(19) United States
(12) Patent Application Publication
(10) Pub. No.: US 2026/0084913 A1
(43) Pub. Date: Mar. 26, 2026

(54) METHOD FOR AUTOMATICALLY REPLACING ELECTRODE REEL OF SECONDARY BATTERY

(71) Applicant: SK On Co., Ltd., Seoul (KR)

(72) Inventor: Joon Ho BAE, Daejeon (KR)

(21) Appl. No.: 19/333,359

(22) Filed: Sep. 19, 2025

(30) Foreign Application Priority Data
Sep. 20, 2024 (KR) 10-2024-0127349

(51) Int. Cl. B65H 19/10; B65H 19/20; H01M 10/04

(52) U.S. Cl. CPC B65H 19/102; B65H 19/20; H01M 10/0431; B65H 2301/415085; B65H 2301/41522; B65H 2301/46018; B65H 2301/46312; B65H 2301/4633; B65H 2402/42; B65H 2553/42; B65H 2553/43; B65H 2701/19

(57) ABSTRACT

Proposed is a method for automatically replacing an electrode reel of a secondary battery which includes a reel holder mounting step, an adhesive providing step, a production reel outer diameter detection step, a production reel moving step, a standby reel supply step, and a material connection step of connecting an electrode material of the production reel of the bobbin buffer part and an electrode material of the standby reel to each other by using the adhesive, and cutting a remaining electrode material of the production reel.

### CROSS REFERENCE TO RELATED APPLICATION

The present application claims priority to Korean Patent Application No. 10-2024-0127349, filed Sep. 20, 2024, the entire contents of which is incorporated herein for all purposes by this reference.

### BACKGROUND

### Technical Field

The present disclosure relates to a method for automatically replacing an electrode reel of a secondary battery.

### Description of the Related Art

Secondary batteries are energy storage devices that are widely used in various fields such as electric vehicles, portable electronic devices, and energy storage systems, and their demand is rapidly increasing.

A notching process, which is one of the manufacturing processes of secondary batteries, is an important step that shapes electrodes and may greatly affect electrode quality and production efficiency. In the notching process of secondary batteries, a roll-to-roll method is mainly used. In this method, a reel on which an electrode material is wound (hereinafter referred to as an “electrode reel”) is unwound to process the electrode material into a desired shape.

In this process, when an electrode material wound on an electrode reel in production (hereinafter referred to as “a production reel”) is exhausted, an electrode material on a standby reel that has been preliminarily provided may be connected to the electrode material of the production reel to be used. However, whenever the electrode material of the production reel is exhausted, a production line may be temporarily suspended.

Accordingly, there is a need for an automatic replacement method capable of automatically replacing an electrode reel when an electrode material is exhausted, thereby improving production efficiency without suspending the production line.

### DOCUMENT OF RELATED ART

(Patent Document 1) KR 10-2021-0058130 A

### SUMMARY

According to an aspect of the present disclosure, it is possible to provide a method for automatically replacing an electrode reel of a secondary battery, in which a production reel and a standby reel are automatically connected when an electrode material is exhausted, thereby automatically replacing an electrode reel without stopping production.

According to another aspect of the present disclosure, the replacement process of an electrode reel is simplified to reduce downtime, lower operator fatigue, and enhance overall productivity, thereby improving operational efficiency.

According to another aspect of the present disclosure, it is possible to provide a method for automatically replacing an electrode reel of a secondary battery, which can be widely applied to green technology fields such as electric vehicles, battery charging stations, and solar and wind power generation using batteries.

In order to achieve the above objectives, according to an aspect of the present disclosure, there is provided a method for automatically replacing an electrode reel of a secondary battery, the method including: a reel holder mounting step of mounting a standby reel on a reel holder and putting the standby reel on standby; an adhesive providing step of providing adhesive to the standby reel mounted on the reel holder; a production reel outer diameter detection step of detecting an outer diameter of a production reel in real time to check a remaining amount of the production reel mounted on a production bobbin; a production reel moving step of moving the production reel to a bobbin buffer part when the remaining amount of the production reel is equal to or less than a reference value; a standby reel supply step of supplying the standby reel on standby in the reel holder to the production bobbin; and a material connection step of connecting an electrode material of the production reel of the bobbin buffer part and an electrode material of the standby reel to each other by using the adhesive, and cutting a remaining electrode material of the production reel.

Here, the reel holder mounting step may include a process in which an automatic guided vehicle (AGV) performs automatic alignment through capturing an image of the reel holder by a vision sensor to mount the standby reel in a correct position on the reel holder.

In addition, the adhesive providing step may include a process in which one of a double-sided tape and a bonding agent is provided as the adhesive.

In addition, the adhesive providing step may include a process of attaching the double-sided tape in a width direction of the standby reel to a specific position of the standby reel when the double-sided tape is used as the adhesive.

In addition, the adhesive providing step may include a process of continuously spraying the bonding agent along a width direction of the standby reel to a specific position thereof or of discontinuously spraying the bonding agent at intervals along the width direction of the standby reel to the specific position thereof when the bonding agent is used as the adhesive.

In addition, the production reel outer diameter detection step may include a process of detecting a change in an outer diameter of the production reel in real time through an outer diameter detection part provided at a position facing the production reel near the production bobbin.

In addition, the method for automatically replacing an electrode reel of a secondary battery may further include: an alignment check step which is provided between the adhesive providing step and the production reel outer diameter detection step and which checks an alignment state between the standby reel mounted on the reel holder and the production reel mounted on the production bobbin through a vision part.

In addition, in the production reel moving step, a bobbin gripper may move between the production bobbin and the bobbin buffer part and moves the production reel, which has the remaining amount equal to or less than the reference value, to the bobbin buffer part.

In addition, when the electrode material of the production reel is unwound during the movement of the production reel, the bobbin buffer part may perform a process of rewinding the unwound electrode material.

In addition, the standby reel supply step may include a process of detecting a barcode on the standby reel after the standby reel is mounted on the production bobbin, checking an end of the electrode material of the standby reel, and then locking the standby reel so as to prevent rotation thereof.

In addition, the material connection step may include a process of pressing the electrode material of the production reel onto the standby reel having the adhesive by using a pressing and cutting part and of cutting the remaining electrode material of the production reel when the electrode materials are adhered to each other.

In addition, the method for automatically replacing an electrode reel of a secondary battery may further include: an adhesive position detection step which is provided between the standby reel supply step and the material connection step and which directly detects a position of the adhesive on the standby reel mounted on the production bobbin.

In addition, the method for automatically replacing an electrode reel of a secondary battery may further include: a production buffer step which is provided between the production reel outer diameter detection step and the production reel moving step and in which an extra electrode material is advanced so that production of the electrode material continues without interruption when the production reel and the standby reel are connected to each other.

In addition, the production buffer step may include a process of continuing the production of the electrode material by using the extra electrode material generated by reduction of a gap between a moving roller and a fixed roller in a production buffer part located upstream of the production bobbin and the bobbin buffer part with respect to an advancing direction of the electrode material.

The features and advantages of the present disclosure will become more apparent from the following detailed description based on the accompanying drawings.

Prior to this, the terms or words used in this specification and claims should not be interpreted in their usual or dictionary meanings, but should be interpreted in their meanings and concepts that are consistent with the technical idea of the present disclosure on the basis of the principle that the inventor can appropriately define the concept of a term to explain his or her own invention in the best way.

According to an embodiment of the present disclosure, an electrode production process can be continuously carried out without interruption, thereby improving production efficiency.

The complex and difficult task of replacing an electrode reel can be automated, thereby reducing labor costs and decreasing operator fatigue.

The electrode material of an existing production reel and the electrode material of a newly supplied standby reel can be accurately connected during the replacement of an electrode reel, thereby improving product quality.

### BRIEF DESCRIPTION OF THE DRAWINGS

FIG. 1 is a flowchart schematically illustrating a method for automatically replacing an electrode reel of a secondary battery according to an embodiment of the present disclosure;

FIG. 2 is a reference view schematically illustrating a process of mounting a standby reel to a reel holder by using an automatic guided vehicle in the embodiment according to the present disclosure;

FIG. 3 is a plan view showing a process of mounting the standby reel to the reel holder by using the automatic guided vehicle in the embodiment according to the present disclosure;

FIG. 4 is a reference view showing a production reel in electrode production and the standby reel waiting on the reel holder;

FIG. 5 is a schematic configuration view showing an embodiment of an adhesive providing part that provides adhesive in the embodiment according to the present disclosure;

FIG. 6 is an operational view showing a state in which a rotary gripper is rotated in FIG. 5;

FIG. 7 is a schematic configuration view showing another embodiment of the adhesive providing part in the embodiment according to the present disclosure;

FIG. 8 is a flowchart illustrating the method for automatically replacing an electrode reel of a secondary battery, which includes an alignment check step, in the embodiment of the present disclosure;

FIG. 9 is a reference view illustrating a process of checking an alignment state between the standby reel mounted on the reel holder and the production reel mounted on a production bobbin by the alignment check step in the embodiment of the present disclosure;

FIG. 10 is a reference view illustrating a process of moving the production reel, whose remaining amount is equal to or less than a reference value, to a bobbin buffer part in the embodiment of the present disclosure;

FIG. 11 is a reference view illustrating a process of mounting the standby reel on the production bobbin after the production reel is moved to the bobbin buffer part in the embodiment of the present disclosure;

FIG. 12 is a reference view illustrating a process in the embodiment of the present disclosure, in which the standby reel is mounted on the production bobbin, the adhesive position of the standby reel is checked, and then the production reel and the standby reel are connected;

FIG. 13 is a flowchart illustrating the method for automatically replacing an electrode reel of a secondary battery, which includes a production buffer step and an adhesive position detection step, in the embodiment of the present disclosure; and

FIG. 14 is a reference view for illustrating the production buffer step in the embodiment of the present disclosure.

### DETAILED DESCRIPTION

Terms used to describe an embodiment of the present disclosure is not intended to limit the disclosure. It should be understood that singular expressions include plural expressions unless explicitly stated otherwise from the context.

In assigning reference numerals to the components shown in the drawings, the same components are assigned the same reference numerals as much as possible, even if they are shown in different drawings, and similar components are assigned similar reference numerals.

The drawings may be shown schematically or exaggeratedly for the purpose of describing the embodiments. In this document, expressions such as “have,” “may have,” “include,” or “may include” indicate the presence of the respective features (e.g., numerical values, functions, operations, or components) and do not exclude the presence of additional features.

Terms such as “one,” “other,” “another,” “first,” and “second” are used to distinguish a component from other components, and the components are not limited by the terms.

Hereinafter, an embodiment of the present disclosure will be described in detail with reference to the accompanying drawings.

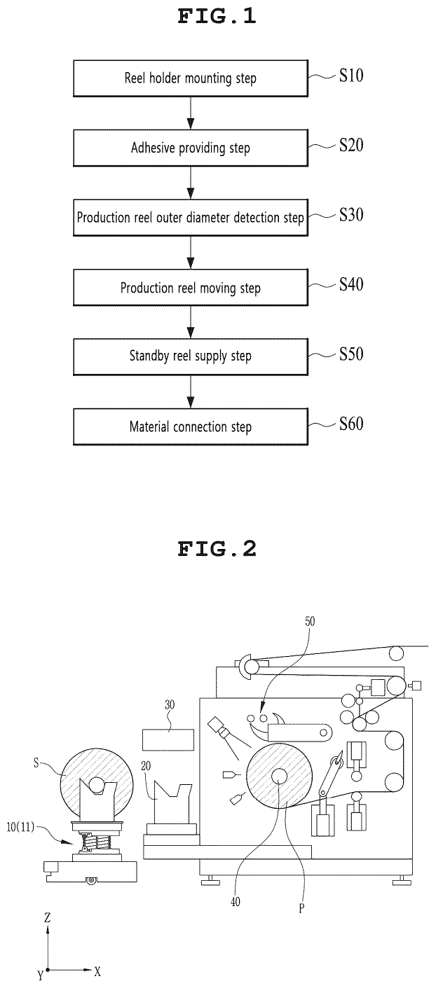

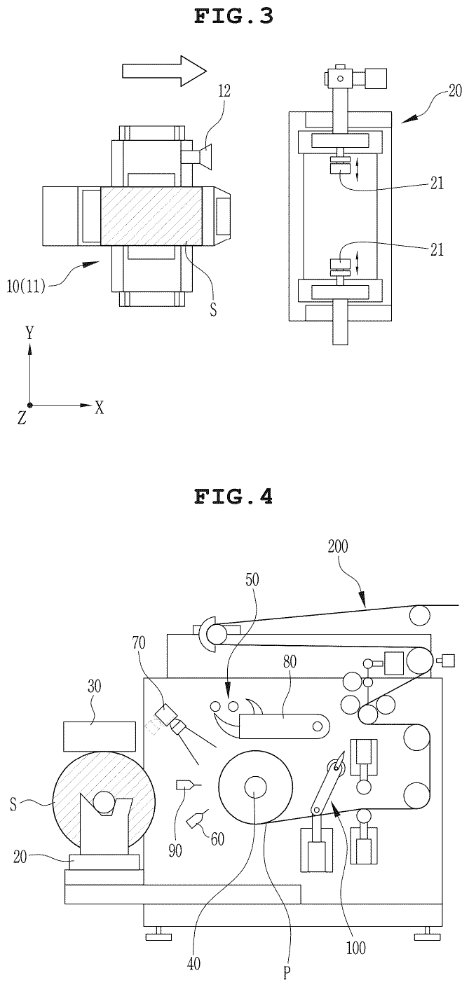

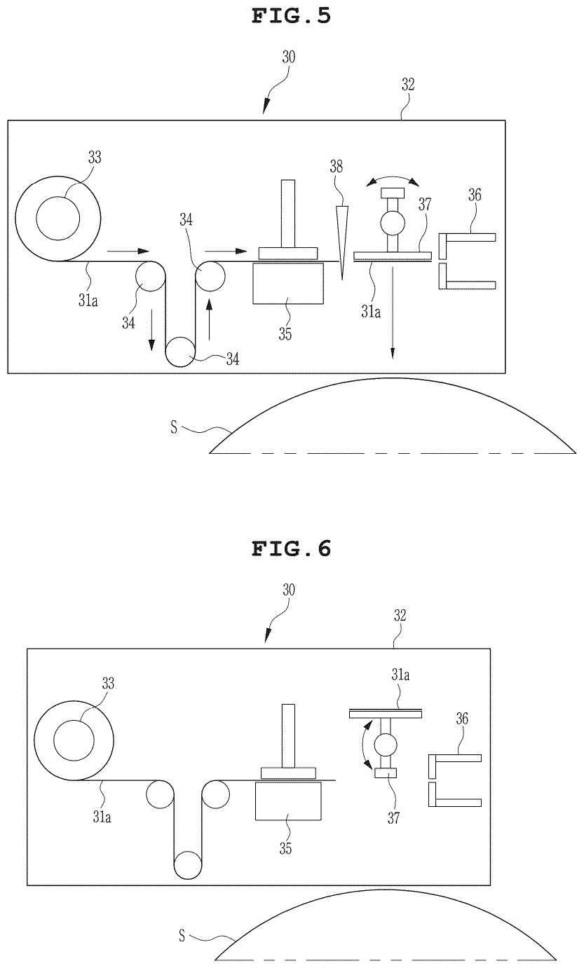

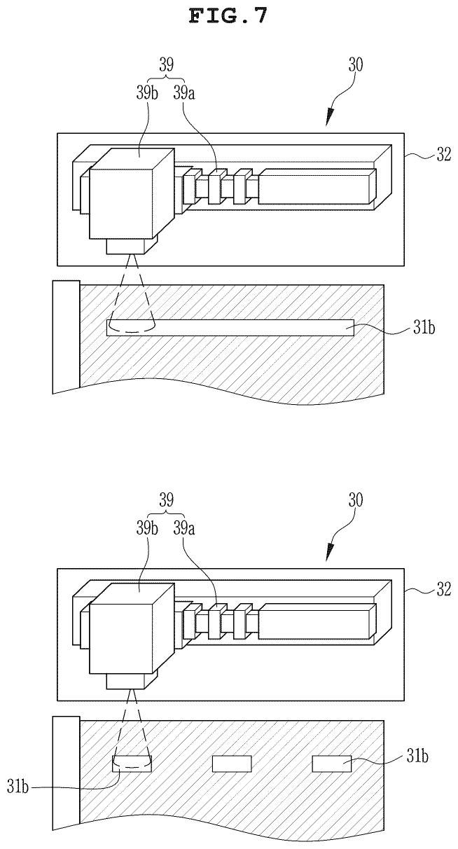

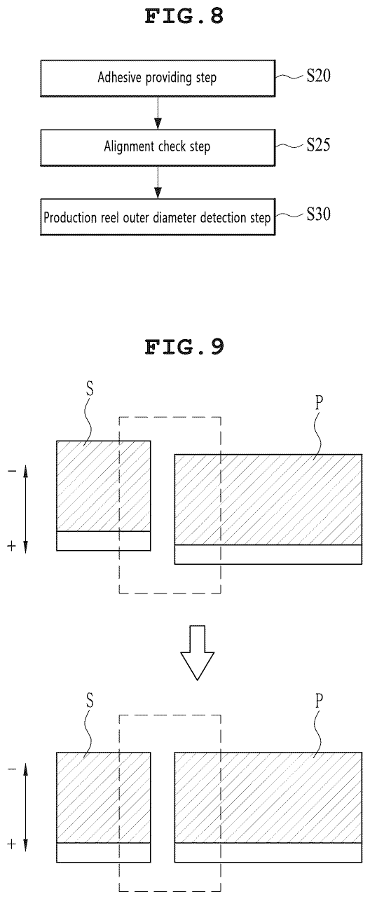

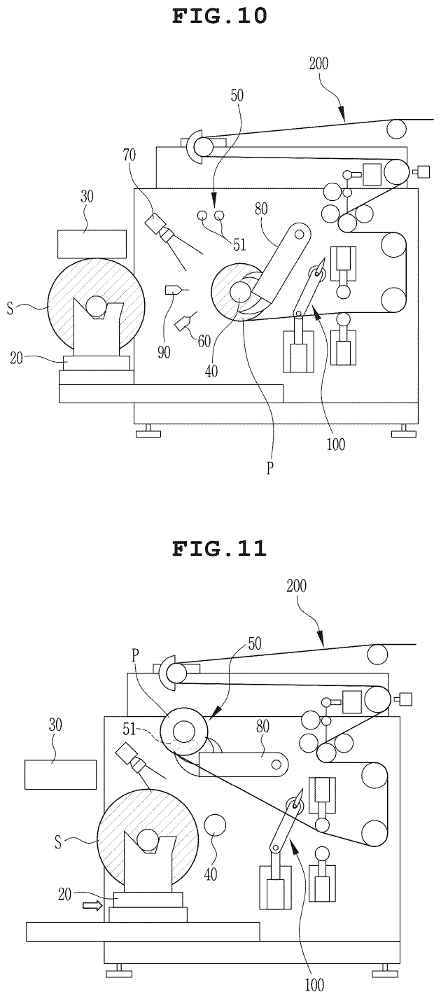

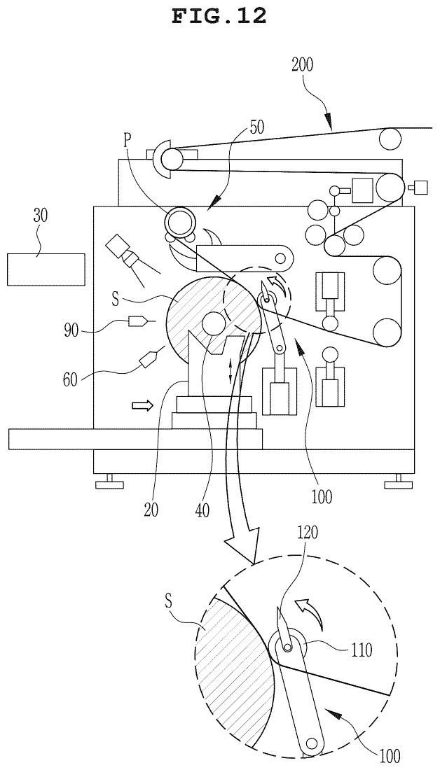

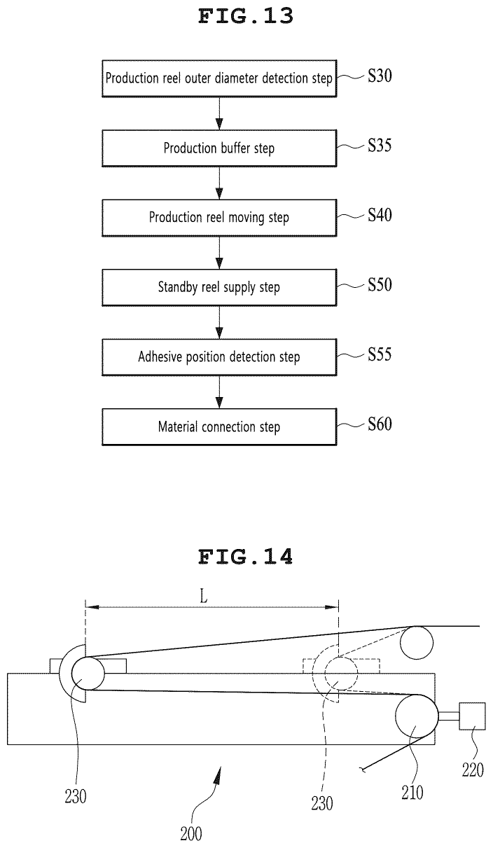

FIG. 1 is a flowchart schematically illustrating a method for automatically replacing an electrode reel of a secondary battery according to an embodiment of the present disclosure; FIG. 2 is a reference view schematically illustrating a process of mounting a standby reel to a reel holder by using an automatic guided vehicle in the embodiment according to the present disclosure; FIG. 3 is a plan view showing a process of mounting the standby reel to the reel holder by using the automatic guided vehicle in the embodiment according to the present disclosure; FIG. 4 is a reference view showing a production reel in electrode production and the standby reel waiting on the reel holder; FIG. 5 is a schematic configuration view showing an embodiment of an adhesive providing part that provides adhesive in the embodiment according to the present disclosure; FIG. 6 is an operational view showing a state in which a rotary gripper is rotated in FIG. 5; FIG. 7 is a schematic configuration view showing another embodiment of the adhesive providing part in the embodiment according to the present disclosure; FIG. 8 is a flowchart illustrating the method for automatically replacing an electrode reel of a secondary battery, which includes an alignment check step, in the embodiment of the present disclosure; FIG. 9 is a reference view illustrating a process of checking an alignment state between the standby reel mounted on the reel holder and the production reel mounted on a production bobbin by the alignment check step in the embodiment of the present disclosure; FIG. 10 is a reference view illustrating a process of moving the production reel, whose remaining amount is equal to or less than a reference value, to a bobbin buffer part in the embodiment of the present disclosure; FIG. 11 is a reference view illustrating a process of mounting the standby reel on the production bobbin after the production reel is moved to the bobbin buffer part in the embodiment of the present disclosure; FIG. 12 is a reference view illustrating a process in the embodiment of the present disclosure, in which the standby reel is mounted on the production bobbin, the adhesive position of the standby reel is checked, and then the production reel and the standby reel are connected; FIG. 13 is a flowchart illustrating the method for automatically replacing an electrode reel of a secondary battery, which includes a production buffer step and an adhesive position detection step, in the embodiment of the present disclosure; and FIG. 14 is a reference view for illustrating the production buffer step in the embodiment of the present disclosure.

As illustrated in FIG. 1, the method for automatically replacing an electrode reel of a secondary battery according to the embodiment of the present disclosure may include a reel holder mounting step S10 of mounting a standby reel S on a reel holder 20 and putting the standby reel S on standby, an adhesive providing step S20 of providing adhesive 31 to the standby reel S mounted on the reel holder 20, a production reel outer diameter detection step S30 of detecting an outer diameter of a production reel P in real time to check the remaining amount of the production reel P mounted on a production bobbin 40, a production reel moving step S40 of moving the production reel P to a bobbin buffer part 50 when the remaining amount of the production reel P is equal to or less than a reference value, a standby reel supply step S50 of supplying the standby reel S on standby in the reel holder 20 to the production bobbin 40, and a material connection step S60 of connecting an electrode material of the production reel P of the bobbin buffer part 50 and an electrode material of the standby reel S to each other by using the adhesive 31, and cutting a remaining electrode material of the production reel P.

The reel holder mounting step S10 may include a process of mounting the standby reel S on the reel holder 20 by using automated logistics equipment 10 capable of mounting and moving the standby reel S.

Here, the automated logistics equipment 10 may include an automatic guided vehicle (AGV) 11, conveyors, racks, and the like. In the present disclosure, the automatic guided vehicle (AGV) 11 is described as an example of the automated logistics equipment 10, but the automated logistics equipment 10 is not limited to the AGV 11, and other types of logistics equipment may also be used as necessary.

For reference, the production reel P may refer to a reel on which an electrode material is currently being produced, and the standby reel S may refer to a reel that is kept on standby in preparation for the exhaustion of the production reel P in the future. In addition, the production bobbin 40 may refer to a bobbin on which the production reel P is mounted to perform electrode production, and the reel holder 20 may refer to a component on which the standby reel S is temporarily mounted after being supplied from the automated logistics equipment 10, such as the AGV 11, and which is transferred when necessary to mount the standby reel S on the production bobbin 40.

As shown in FIG. 2, in the reel holder mounting step S10, the automated logistics equipment 10 (for example, the AGV 11) mounts a standby reel S to be newly supplied on the reel holder 20. In this case, the AGV 11 may detect a correct position of the reel holder 20 and mount the standby reel S in a correct position on the reel holder 20.

Referring to FIG. 3, the reel holder mounting step S10 may include a process in which the AGV 11 performs automatic alignment through capturing an image of the reel holder 20 by a vision sensor 12 to mount the standby reel S in the correct position on the reel holder 20.

To implement this, the vision sensor 12 capable of capturing an image may be provided on one side of the AGV 11. The AGV 11 may capture an image of the reel holder 20 through the vision sensor 12, thereby accurately identifying the position of a holder bobbin 21, on which the standby reel S is to be mounted, in the reel holder 20.

After identifying the position of the holder bobbin 21 of the reel holder 20, the AGV 11 may perform automatic alignment to mount the standby reel S in a correct position on the holder bobbin 21. During the automatic alignment, the AGV 11 may horizontally move in an X-direction to the lower side of the reel holder 20, and may also horizontally move in a Y-direction intersecting the X-direction to align the position of the standby reel S with the holder bobbin 21, thereby enabling automatic alignment.

In addition, in order to raise the standby reel S to the position of the holder bobbin 21 of the reel holder 20, the AGV 11 may vertically move in a Z-direction while carrying the standby reel S to automatically align the standby reel S, and then may mount the standby reel S in the correct position on the holder bobbin 21 of the reel holder 20.

In this way, when the standby reel S is placed at the correct position by the AGV 11, the holder bobbin 21 of the reel holder 20 may be inserted into the rotational center side of the standby reel S, so that the standby reel S may be mounted on the reel holder 20.

In addition, when the standby reel S is completely mounted on the reel holder 20, the adhesive providing step S20 may be performed.

In the adhesive providing step S20, the adhesive 31 may be provided to a specific position of the standby reel S mounted on the reel holder 20. The adhesive 31 is intended to bond and connect the electrode material of the existing production reel P with the electrode material of the newly supplied standby reel S, and various products such as a double-sided tape 31a or a bonding agent 31b may be provided as the adhesive 31.

That is, the adhesive providing step S20 may include a process in which one of the double-sided tape 31a and the bonding agent 31b is provided as the adhesive 31.

As shown in FIG. 4, in order to perform the adhesive providing step S20 according to the present disclosure, an adhesive providing part 30 for providing the double-sided tape 31a or the bonding agent 31b to the standby reel S may be provided on the upper side of the standby reel S mounted on the reel holder 20.

Here, the adhesive providing step S20 may include a process of attaching the double-sided tape 31a in a width direction (a Y-direction) of the standby reel S to a specific position of the standby reel S when the double-sided tape 31a is used as the adhesive 31.

As shown in FIG. 5, an embodiment of the adhesive providing part 30 for performing the adhesive providing step S20 may specifically include the following configuration.

The adhesive providing part 30 according to the embodiment may include a housing 32, a tape unwinder 33, a plurality of intermediate rollers 34, a guide block 35, a tape gripper 36, a rotary gripper 37, and a tape cutter 38.

The housing 32 may constitute the overall exterior of the adhesive providing part 30 and may be provided as a structure in which the other components of the adhesive providing part 30 are contained. The housing 32 may be disposed on the upper side of the standby reel S so as to be in contact with an electrode material wound on the standby reel S.

The tape unwinder 33 may be provided inside the housing 32 to wind the double-sided tape 31a and, when necessary, to unwind the wound double-sided tape 31a. In this case, a release liner may be attached to one surface of the double-sided tape 31a.

The intermediate rollers 34 may be arranged at predetermined intervals so that the double-sided tape 31a unwound from the tape unwinder 33 is conveyed along a preset conveyance path.

The guide block 35 may be provided to flatten the double-sided tape 31a that has been bent or deformed during the conveyance process and to guide the conveyance of the double-sided tape 31a.

The tape gripper 36 may be provided to grip the double-sided tape 31a and to pull the double-sided tape 31a while moving in one direction from the guide block 35 while gripping the double-sided tape 31a.

The rotary gripper 37 may be capable of suctioning the double-sided tape 31a, which has been moved in the one direction by the tape gripper 36, between the guide block 35 and the tape gripper 36, and may be moved toward the standby reel S to attach the suctioned double-sided tape 31a to the outer surface of an electrode material on the standby reel S.

In this case, the rotary gripper 37 may attach the double-sided tape 31a with the release liner to the outer surface of the electrode material, or may attach the double-sided tape 31a without the release liner or with the release liner previously removed to the outer surface of the electrode material.

In addition, the tape cutter 38 may be provided between the guide block 35 and the tape gripper 36 to cut the double-sided tape 31a to a preset length while the rotary gripper 37 is holding the double-sided tape 31a by suction. When the tape cutter 38 cuts the double-sided tape 31a to a predetermined length, the rotary gripper 37 may move toward the standby reel S while holding the double-sided tape 31a by suction and attach the double-sided tape 31a to a specific position on the standby reel S.

Meanwhile, when a problem occurs with the double-sided tape 31a gripped by suction on the rotary gripper 37, the rotary gripper 37 may be provided to be rotatable, as shown in FIG. 6, in order to remove or detach the suctioned double-sided tape 31a gripped by suction.

For example, if a problem occurs with the double-sided tape 31a, such as poor quality or issues with its size, shape, or adhesiveness, the rotary gripper 37 may be rotated, as shown in FIG. 6, to remove or detach the double-sided tape 31a gripped by suction and either attach the double-sided tape 31a to a surrounding structure or allow the double-sided tape 31a to drop.

In addition, in the adhesive providing step S20 according to an embodiment of the present disclosure, when the bonding agent 31b is used as the adhesive 31, a process of continuously spraying the bonding agent 31b along a width direction of the standby reel S to a specific position thereof or of discontinuously spraying the bonding agent 31b at intervals along the width direction of the standby reel S to the specific position thereof may be performed.

As shown in FIG. 7, another embodiment of the adhesive providing part 30 for performing the adhesive providing step S20 may specifically include the following configuration.

According to the other embodiment, the adhesive providing part 30 may include a housing 32 and a bonding agent spraying part 39.

The housing 32 may constitute the overall exterior of the adhesive providing part 30 and may be arranged on the upper side of the standby reel S so as to be in contact with an electrode material wound on the standby reel S.

The bonding agent spraying part 39 may be provided inside the housing 32 so as to spray the bonding agent 31b along the width direction of the standby reel S at a specific position of the standby reel S. The bonding agent spraying part 39 may include a body part 39a and a head part 39b that moves along the longitudinal direction of the body portion 39a and sprays the bonding agent 31b.

When the head part 39b sprays the bonding agent 31b while moving along the longitudinal direction of the body part 39a, the bonding agent 31b may be provided along the width direction of the standby reel S.

In this case, as shown in the upper drawing of FIG. 7, the bonding agent 31b sprayed along the width direction to a specific position of the standby reel S may be continuously sprayed on the electrode material of the standby reel S, and as shown in the lower drawing of FIG. 7, the bonding agent 31b may also be sprayed discontinuously at predetermined intervals, which may be appropriately selected according to the needs of a practitioner.

Meanwhile, referring again to FIG. 4, the production reel outer diameter detection step S30 may include a process of detecting, in real time, the outer diameter of the production reel P, which is mounted on the production bobbin 40 and currently producing an electrode, in order to check the remaining amount of the production reel P.

The production reel outer diameter detection step S30 may be performed by an outer diameter detection part 60 provided near the production reel P, wherein the outer diameter detection part 60 may detect the outer diameter of the production reel P to detect the exhaustion of an electrode material wound around the production reel P.

That is, the production reel outer diameter detection step S30 may include a process of detecting a change in the outer diameter of the production reel P in real time through the outer diameter detection part 60 provided at a position facing the production reel P near the production bobbin 40.

Here, the outer diameter detection part 60 may employ a non-contact displacement sensor, and detect the outer diameter of the production reel P in real time, and when the measured value of the outer diameter is equal to or less than the reference value, it may serve as a reference for determining the replacement timing of the production reel P.

When the replacement timing of the production reel P is reached as determined by the outer diameter detection part 60, the production reel moving step S40 may be performed.

As shown in FIG. 8, the method for automatically replacing an electrode reel of a secondary battery according to the present disclosure may further include an alignment check step S25 which is provided between the adhesive providing step S20 and the production reel outer diameter detection step S30 and which checks an alignment state between the standby reel S mounted on the reel holder 20 and the production reel P mounted on the production bobbin 40 through a vision part 70.

In the alignment check step S25, a process of pre-checking an alignment state between the existing production reel P and the standby reel S to be supplied before mounting the standby reel S of the reel holder 20 onto the production bobbin 40 may be may performed, thereby ensuring that when the standby reel S of the reel holder 20 is subsequently mounted onto the production bobbin 40, the standby reel S is mounted in a correct position on the production bobbin 40.

To this end, as shown in FIG. 4, the vision part 70 may be positioned between the standby reel S and the production reel P so as to be rotatable when necessary, and may sequentially capture images of the standby reel S and the production reel P to acquire the images.

Accordingly, as shown in FIG. 9, in the alignment check step S25, the images of the standby reel S and the production reel P captured by the vision part 70 may be extracted and compared with each other to check the alignment state between the two reels.

Accordingly, as shown in the upper drawing of FIG. 9, when the images of the standby reel S and the production reel P are misaligned, a separately provided controller may correct the position of the standby reel S by controlling the holder bobbin 21 of the reel holder 20 on which the standby reel S is mounted, thereby aligning the standby reel S and the production reel P as shown in the lower drawing of FIG. 9.

When the alignment state of the standby reel S is satisfactory and the production bobbin 40 is empty, the standby reel S may be immediately mounted onto the production bobbin 40, thereby reducing reel replacement time.

The production reel moving step S40 may include a process of moving the production reel P to the bobbin buffer part 50 when the remaining amount of the production reel P, as determined by the production reel outer diameter detection step S30, is equal to or less than the reference value.

Here, the production reel moving step S40 may include a process in which a bobbin gripper 80 moves between the production bobbin 40 and the bobbin buffer part 50 and moves the production reel P, which has the remaining amount equal to or less than the reference value, to the bobbin buffer part 50.

As shown in FIG. 10, in the production reel moving step S40, the production reel P, whose remaining amount is equal to or less than the reference value, may be moved from the production bobbin 40 to the bobbin buffer part 50 by the bobbin gripper 80 provided near the production bobbin 40.

The bobbin gripper 80, which is configured to move the production reel P of the production bobbin 40 to the bobbin buffer part 50 by moving between the production bobbin 40 and the bobbin buffer part 50, may be provided in the form of a robot with multiple joints.

Accordingly, when the outer diameter of the production reel P is equal to or less than the reference value as determined by the production reel outer diameter detection step S30, it is determined that it is the replacement timing of the production reel P, and the production reel moving step S40 is performed. In this case, the bobbin gripper 80 may load the production reel P from the production bobbin 40 and unload the production reel P to the bobbin buffer part 50 provided around the production bobbin 40.

While the production reel P is being moved from the production bobbin 40 to the bobbin buffer part 50, the supply of electrode material from the corresponding production reel P may be temporarily interrupted. In this situation, a production buffer step S35, which will be described later, may be provided to ensure that the overall production of electrode material is not interrupted and continues. The production buffer step S35 will be described in detail later.

Meanwhile, when the electrode material of the production reel P is unwound during the movement of the production reel P, the bobbin buffer part 50 may perform a process of rewinding the unwound electrode material.

As illustrated in FIG. 11, during the process in which the production reel P is moved to the bobbin buffer part 50 by the bobbin gripper 80, the electrode material wound on the production reel P may be arbitrarily unwound. When the electrode material is unwound from the production reel P, the bobbin buffer part 50 may rewind the unwound electrode material.

Here, the bobbin buffer part 50 may include a plurality of drive rollers 51, and the drive rollers 51 are in contact with the rotational center shaft of the production reel P to rotate the production reel P in the winding direction of the electrode material, thereby rewinding the unwound electrode material.

Furthermore, referring to FIG. 11, when the production reel P is moved to the bobbin buffer part 50, the production bobbin 40 is empty, and in the standby reel supply step S50, the standby reel S on standby may be supplied to the empty production bobbin 40.

The standby reel supply step S50 is a step of supplying the standby reel S, which is on standby on the reel holder 20, to the production bobbin 40, wherein the standby reel S at this time may be the standby reel S whose alignment has been completed by the alignment check step S25 described above.

As shown in FIG. 12, in order to mount the standby reel S on the production bobbin 40, the reel holder 20 may move toward the production bobbin 40, and as the reel holder 20 is raised or lowered in a vertical direction (a Z direction), the standby reel S may be mounted on the production bobbin 40. After the standby reel S is completely mounted on the production bobbin 40, the reel holder 20 may return to an original position thereof.

Here, the standby reel supply step S50 includes a process of detecting a barcode on the standby reel S after the standby reel S is mounted on the production bobbin 40, checking the end of the electrode material of the standby reel S, and then locking the standby reel S so as to prevent rotation thereof.

That is, when the standby reel S is mounted on the production bobbin 40, the position of the adhesive 31 attached to the standby reel S must first be checked in order to connect the electrode material of the standby reel S to the production reel P. When the position of the adhesive 31 is checked, the standby reel S may be locked to prevent the standby reel S from rotating so that the position of the adhesive 31 does not change.

In the standby reel supply step S50, in order to check the position of the adhesive 31 provided on the standby reel S, the barcode attached to the standby reel S may be detected by a barcode reader 90 provided near the production bobbin 40.

For reference, since the barcode is typically attached to the end of the electrode material of the standby reel S, detecting the position of the barcode by using the barcode reader 90 makes it possible to identify the end of the electrode material. In addition, the adhesive 31 is also attached around the end of the electrode material around the barcode, and thus when the position of the barcode and the end of the electrode material are checked, the position of the adhesive 31 may be indirectly checked. When the position of the barcode is detected through the checking of the position of the adhesive 31 by such a method, it is determined that the position of the adhesive 31 has also been detected, and the standby reel S may be locked so that the position of the adhesive 31 does not change.

Meanwhile, referring to FIG. 12, in the material connection step S60, the electrode material of the production reel P located in the bobbin buffer part 50 and the electrode material of the standby reel S located on the production bobbin 40 are connected to each other by the adhesive 31, and the remaining electrode material of the production reel P may be cut.

That is, the material connection step S60 may include a process of pressing the electrode material of the production reel P onto the standby reel S having the adhesive 31 by using a pressing and cutting part 100 and of cutting the remaining electrode material of the production reel P when the electrode materials are adhered to each other.

Here, the pressing and cutting part 100 may include a pressing roller 110 and a cutter 120.

The pressing and cutting part 100 may be provided near the production bobbin 40, and the pressing roller 110 may press the electrode materials of the production reel P and the standby reel S together so that the electrode materials are adhered to each other by the adhesive 31 provided on the standby reel S.

The pressing roller 110 may provide a pressing force in the radial direction of the standby reel S so that the electrode materials are supported by a reaction force when pressed. The pressing roller 110 may be pivotably provided so as to be spaced apart from the standby reel S in a normal state and, during pressing, move in the radial direction of the standby reel S to press the electrode materials.

The cutter 120 extends from the pressing roller 110 and may be provided to cut the remaining electrode material of the production reel P after the electrode material of the production reel P and the electrode material of the standby reel S are connected to each other.

Specifically, the cutter 120 may protrude from the pressing roller 110 by a predetermined length so as to extend rearward with respect to the movement path of the electrode material. When the electrode materials of the production reel P and the standby reel S are connected to each other by the pressing roller 110, the cutter 120 may cut the remaining electrode material of the production reel P, thereby separating the remaining electrode material of the production reel P connected to the electrode material of the standby reel S.

After the cutter 120 cuts the remaining electrode material of the production reel P, the electrode material of the production reel P no longer proceeds, and the electrode material of the standby reel S, connected by the adhesive 31, continues along the preset conveyance path.

Meanwhile, as illustrated in FIG. 13, the method for automatically replacing an electrode reel of a secondary battery may further include an adhesive position detection step S55 which is provided between the standby reel supply step S50 and the material connection step S60 and which directly detects the position of the adhesive 31 on the standby reel S mounted on the production bobbin 40.

The adhesive position detection step S55 may be provided in place of the step of indirectly checking the position of the adhesive 31 through barcode detection in the standby reel supply step S50 described above, or may be additionally provided to directly check the position of the adhesive 31 once again.

That is, in the adhesive position detection step S55, the position of the adhesive 31 provided on the standby reel S of the production bobbin 40 may be directly detected by photographing the standby reel S through the vision part 70 described above.

When the vision part 70 captures the image of the standby reel S to detect the position of the adhesive 31, the standby reel S may be rotated at least once at a low speed even when the standby reel S is locked through the standby reel supply step S50 described above.

In the adhesive position detection step S55, even if the position of the adhesive 31 has been indirectly checked in the standby reel supply step S50, a process of directly rechecking the position of the adhesive 31 through the vision part 70 may be performed, thereby improving the reliability of checking the position of the adhesive 31.

Referring to FIG. 13, the method for automatically replacing an electrode reel of a secondary battery according to the present disclosure may further include a production buffer step S35, which is provided between the production reel outer diameter detection step S30 and the production reel moving step S40, and in which an extra electrode material is advanced so that the production of the electrode material continues without interruption when the production reel P and the standby reel S are connected to each other.

The production buffer step S35 may be provided to compensate for a phenomenon in which the production of the electrode material is temporarily interrupted while the existing production reel P is moved from the production bobbin 40 to the bobbin buffer part 50, the standby reel S is supplied to the position of the production bobbin 40, and the electrode material of the production reel P is connected to the electrode material of the standby reel S.

According to the production buffer step S35, the extra electrode material on the conveyance path of the electrode material is advanced, so that, overall, the production of the electrode material can continue without interruption.

Here, the production buffer step S35 may include a process of continuing the production of the electrode material by using the extra electrode material generated by reduction of a gap between a moving roller 230 and a fixed roller 210 in a production buffer part 200 located upstream of the production bobbin 40 and the bobbin buffer part 50 with respect to the advancing direction of the electrode material.

In other words, the production buffer step S35 may cause the extra electrode material to be generated in the production buffer part 200, which is located upstream of the production bobbin 40 and the bobbin buffer part 50 on the conveyance path, when the production of the electrode material is in the condition of being interrupted during the replacement and connection process of the production reel P and the standby reel S. The generation of the extra electrode material may be achieved by the movement of the moving roller 230, and by supplying the extra electrode material from the production buffer part 200, the production of the electrode material may continue without interruption.

The production buffer part 200 may be located upstream of the production bobbin 40 and the bobbin buffer part 50 on the conveyance path of the electrode material. Accordingly, even if the advancement of the electrode material is interrupted at the production bobbin 40 and the bobbin buffer part 50, the extra electrode material may be advanced in the production buffer part 200 so that the overall production can continue without interruption.

As shown in FIG. 14, the production buffer part 200 may include the fixed roller 210, a stopper 220, and the moving roller 230.

The fixed roller 210 may be provided so as to be fixedly positioned on the conveyance path to allow the electrode material to be conveyed along a preset path. The fixed roller 210 may change the conveyance direction of the electrode material, so that the electrode material may be conveyed while wrapping around at least a portion of the outer periphery of the fixed roller 210. The fixed roller 210 may include one fixed roller or at least two fixed rollers as needed, but in the accompanying drawings, one fixed roller 210 is shown to be provided for ease of explanation and understanding.

The stopper 220 is positioned near the fixed roller 210 to be spaced apart from the fixed roller 210, and may be provided to protrude toward the fixed roller 210 as needed. When the stopper 220 protrudes toward the fixed roller 210, the rotation of the fixed roller 210 is restricted, so that the advancement of the electrode material from the production bobbin 40 and the bobbin buffer part 50 to the fixed roller 210 may be interrupted. During the operation of the production buffer part 200, the stopper 220 may protrude toward the fixed roller 210 to restrict the rotation of the fixed roller 210.

The moving roller 230 is positioned at a predetermined distance apart from the fixed roller 210 and may also be disposed on the conveyance path of the electrode material. The moving roller 230 may change the conveyance direction of the electrode material, so that the electrode material may be conveyed while wrapping around at least a portion of the outer periphery of the moving roller 230.

The moving roller 230 may be provided to be movable in a direction closer to or farther away from the fixed roller 210. Accordingly, when the electrode material is advanced from the production reel P mounted on the production bobbin 40, the moving roller 230 may be positioned at a first point (the solid line position of the moving roller 230 in the drawing), which is relatively spaced apart from the fixed roller 210.

In addition, as shown in FIG. 14, when the production reel P and the standby reel S are replaced and connected, the moving roller 230 may move in a direction closer to the fixed roller 210 and may be positioned at a second point (the dashed line position of the moving roller 230 in the drawing).

In this manner, by configuring the moving roller 230 to move from the first point to the second point, the electrode material may generate an extra electrode material having a length 2L corresponding to at least twice the distance L between the first point and the second point. Accordingly, even if the advancement of the electrode material is interrupted at the production bobbin 40 and the bobbin buffer part 50, the production of the electrode material may continue without interruption by using the extra electrode material thus generated.

In this case, the amount of the extra electrode material generated by the production buffer part 200 may be appropriately set in consideration of the interruption time of the advancement at the production bobbin 40 and the bobbin buffer part 50. Specifically, the amount of extra electrode material may be increased or decreased depending on the distance L between the first point and the second point, which is the movement range of the moving roller 230, and may also be increased by increasing the number of the fixed roller 210 and the moving roller 230.

For example, when a plurality of fixed rollers 210 and a plurality of moving rollers 230 are provided and arranged in a zigzag pattern, the length of the extra electrode material generated by the movement of the moving rollers 230 may be further increased. This may be appropriately selected and applied according to the needs of a practitioner.

In addition, when the production reel P is replaced with the standby reel S and the production reel P and the standby reel S are connected to each other, the stopper 220, which is restricting the rotation of the fixed roller 210, returns to the original position thereof, and the moving roller 230 also returns to the original position thereof, that is, the first point. Accordingly, the electrode material from the standby reel S mounted on the production bobbin 40 may be normally unwound, allowing the production of the electrode material to proceed normally. For reference, when the conveyance of the electrode material starts from the standby reel S which has been newly mounted on the production bobbin 40, the standby reel S may now be used as the production reel P.

Meanwhile, the existing production reel P remaining in the bobbin buffer part 50 may undergo a withdrawal step. In the withdrawal step, the existing production reel P may be used as a waste bobbin with almost no electrode material remaining, and the waste bobbin may be moved to another location by a bobbin removal device. For reference, the bobbin removal device may use a transport apparatus such as an automatic guided vehicle (AGV) or an overhead transport (OHT) system.

The present disclosure has been described in detail with reference to specific embodiments. The embodiments are provided merely to illustrate the present disclosure, and the present disclosure is not intended to limit the appended claims. It will be apparent to those skilled in the art that various modifications and changes to the embodiments may be made within the scope and technical spirit of the present disclosure, and such modifications and changes are naturally considered to fall within the scope of the appended claims.

What is claimed is:

1. A method for automatically replacing an electrode reel of a secondary battery, the method comprising:
a reel holder mounting step of mounting a standby reel on a reel holder and putting the standby reel on standby;
an adhesive providing step of providing adhesive to the standby reel mounted on the reel holder;
a production reel outer diameter detection step of detecting an outer diameter of a production reel in real time to check a remaining amount of the production reel mounted on a production bobbin;
a production reel moving step of moving the production reel to a bobbin buffer part when the remaining amount of the production reel is equal to or less than a reference value;
a standby reel supply step of supplying the standby reel on standby in the reel holder to the production bobbin; and
a material connection step of connecting an electrode material of the production reel of the bobbin buffer part and an electrode material of the standby reel to each other by using the adhesive, and cutting a remaining electrode material of the production reel.

2. The method of claim 1, wherein the reel holder mounting step includes a process in which an automatic guided vehicle (AGV) performs automatic alignment through capturing an image of the reel holder by a vision sensor to mount the standby reel in a correct position on the reel holder.

3. The method of claim 1, wherein the adhesive providing step includes a process in which one of a double-sided tape and a bonding agent is provided as the adhesive.

4. The method of claim 3, wherein the adhesive providing step includes a process of attaching the double-sided tape in a width direction of the standby reel to a specific position of the standby reel when the double-sided tape is used as the adhesive.

5. The method of claim 3, wherein the adhesive providing step includes a process of continuously spraying the bonding agent along a width direction of the standby reel to a specific position thereof or of discontinuously spraying the bonding agent at intervals along the width direction of the standby reel to the specific position thereof when the bonding agent is used as the adhesive.

6. The method of claim 1, wherein the production reel outer diameter detection step includes a process of detecting a change in an outer diameter of the production reel in real time through an outer diameter detection part provided at a position facing the production reel near the production bobbin.

7. The method of claim 1, further comprising:
an alignment check step which is provided between the adhesive providing step and the production reel outer diameter detection step and which checks an alignment state between the standby reel mounted on the reel holder and the production reel mounted on the production bobbin through a vision part.

8. The method of claim 1, wherein in the production reel moving step, a bobbin gripper moves between the production bobbin and the bobbin buffer part and moves the production reel, which has the remaining amount equal to or less than the reference value, to the bobbin buffer part.

9. The method of claim 8, wherein when the electrode material of the production reel is unwound during the movement of the production reel, the bobbin buffer part performs a process of rewinding the unwound electrode material.

10. The method of claim 1, wherein the standby reel supply step includes a process of detecting a barcode on the standby reel after the standby reel is mounted on the production bobbin, checking an end of the electrode material of the standby reel, and then locking the standby reel so as to prevent rotation thereof.

11. The method of claim 1, wherein the material connection step includes a process of pressing the electrode material of the production reel onto the standby reel having the adhesive by using a pressing and cutting part and of cutting the remaining electrode material of the production reel when the electrode materials are adhered to each other.

12. The method of claim 11, further comprising:
an adhesive position detection step which is provided between the standby reel supply step and the material connection step and which directly detects a position of the adhesive on the standby reel mounted on the production bobbin.

13. The method of claim 1, further comprising:
a production buffer step which is provided between the production reel outer diameter detection step and the production reel moving step and in which an extra electrode material is advanced so that production of the electrode material continues without interruption when the production reel and the standby reel are connected to each other.

14. The method of claim 13, wherein the production buffer step includes a process of continuing the production of the electrode material by using the extra electrode material generated by reduction of a gap between a moving roller and a fixed roller in a production buffer part located upstream of the production bobbin and the bobbin buffer part with respect to an advancing direction of the electrode material.
